(19) United States
(12) Patent Application Publication
(10) Pub. No.: US 2014/0346903 A1
(43) Pub. Date: Nov. 27, 2014

(54) FAN MOTOR

(71) Applicant: SAMSUNG ELECTRO-MECHANICS CO., LTD., Suwon (KR)

(72) Inventors: Jung Kyu Yim, Suwon (KR); Hae Jun Yang, Suwon (KR); Hyun Kag Park, Suwon (KR); Ki Young Lee, Suwon (KR)

(73) Assignee: SAMSUNG ELECTRO-MECHANICS CO., LTD., Suwon (KR)

(21) Appl. No.: 14/053,317

(22) Filed: Oct. 14, 2013

(30) Foreign Application Priority Data
May 27, 2013 (KR) 10-2013-0059684

(51) Int. Cl. H02K 5/16; H02K 11/00

(52) U.S. Cl. CPC H02K 5/163; H02K 11/0068
USPC 310/43; 310/68 R

(57) ABSTRACT

Disclosed herein is a fan motor. In the fan motor according to the present invention which is an outer rotor type, a shaft having a fan fastened thereto is rotatably coupled to a bearing, the bearing is coupled to a bearing holder formed in a bracket, and the bracket is integrally configured of the bearing holder, a hub formed to be extended from the bearing holder to a perimeter, and a base formed to be extended from the hub to a perimeter, such that parts and assembling process may be effectively reduced. Meanwhile, the shaft is fastened with a stopper to prevent floating thereof, thereby improving driving stability and reliability.

### CROSS REFERENCE TO RELATED APPLICATION

This application claims the benefit of Korean Patent Application No. 10-2013-0059684, filed on May 27, 2013, entitled “Fan Motor”, which is hereby incorporated by reference in its entirety into this application.

### BACKGROUND OF THE INVENTION

1. Technical Field

The present invention relates to a fan motor.

2. Description of the Related Art

A fan motor related to the present invention is disclosed in Patent Document 1. In accordance with Patent Document 1, a refrigerator has the fan motor for promoting a flow of air therein, wherein the fan motor is configured of a fan having a hub and a blade, a rotor received and installed in the hub, a stator disposed in the rotator so as to have a predetermined gap, and a shaft fastened to the rotator and the fan.

Here, both ends of the shaft are provided with a plurality of bearing assemblies for rotatably supporting the shaft and the stator is provided to a perimeter of the bearing assembly. In addition, the fan is configured of an axial-flow fan formed in a propeller shape by having a plurality of blades so that air may be ventilated in a shaft line direction.

Meanwhile, the fan motor disclosed in Patent Document 1, which is an outer rotor type, is installed in a set by coupling a base described as a housing to a bracket described as a supporting member. In this case, the bracket is used by a set manufacturer and a fan motor manufacturer uses the bracket by adding a separate connecting member in order to easily use the bracket.

Therefore, under a structure disclosed in Patent Document 1, various members for installing the fan motor should be provided, which causes an assembly process or the like to be added.

On the other hand, Patent Document 1 uses a snap ring (for example, a C-ring and an E-ring) in order to prevent a protrusion of the fan of the fan motor. That is, in the case in which the shaft floats by fastening the snap ring to the shaft assembled with the fan, the snap ring contacts a bearing housing so as to serve as a kind of stopper, thereby preventing the protrusion of the fan.

Thereby, under the structure disclosed in Patent Document 1, a length of the shaft is increased in order to fasten the snap ring to the shaft and as a result, a shafting of the fan motor may be increased. In addition, since the shaft is exposed to the outside of the bearing housing, bearing oil may be leaked or foreign material containing vapor may permeate into the bearing while operating the fan motor.

[Prior Art Document]

[Patent Document]

(Patent Document 1) KR 2009-0088233 A

### SUMMARY OF THE INVENTION

Therefore, according to the present invention, a base of a fan motor is configured to be integrally formed with a bracket on which the fan motor is installed and is improved so as to have various functions, such that several problems generated under a structure of Patent Document 1 are solved.

The present invention has been made in an effort to provide a fan motor capable of easily simplifying an assembly structure and a process for this and capable of minimizing assembly tolerance.

The present invention has been made in an effort to provide a fan motor capable of easily reducing a shafting and further capable of easily preventing oil leakage and foreign material permeation.

According to a preferred embodiment of the present invention, there is provided a fan motor, including: a shaft having a fan fastened thereto; a bearing rotatably supporting the shaft; and a bracket having a bearing holder having a receiving space receiving the bearing formed therein and a core provided to the outside thereof, a hub formed to be extended from the bearing holder to a perimeter thereof and receiving a printed circuit board, and a base formed to be extended from the hub to a perimeter thereof formed integrally with one another.

The receiving space may be provided with a step part for matching a height of the bearing.

The receiving space may be provided with a washer.

The receiving space may be provided with a protrusion part for matching a height of the washer.

The hub may be provided with a fixing part fixing the printed circuit board (PCB). The bearing holder may have a catching part for matching a height of the core formed at the outside thereof.

According to another preferred embodiment of the present invention, there is provided a fan motor, including: a shaft having a fan fastened thereto; a bearing rotatably supporting the shaft; a bracket having a bearing holder having a receiving space receiving the bearing and an installing space separated from the receiving space by a partition formed therein and a core provided to the outside thereof, a hub formed to be extended from the bearing holder to a perimeter thereof and receiving a printed circuit board, and a base formed to be extended from the hub to a perimeter thereof formed integrally with one another; and a stopper penetrating through the receiving space so as to be fastened to one end of the shaft exposed to the installing space.

The stopper may be formed by injecting plastic.

The fan motor may further include a case sealing the installing space.

The base may be provided with a fixing part fixing the printed circuit board (PCB).

The bearing holder may have a catching part for matching a height of the core formed at the outside thereof.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exploded perspective view showing a fan motor according to a preferred embodiment of the present invention;

FIG. 2 is a perspective view showing a cutaway part of the fan motor according to the preferred embodiment of the present invention;

FIG. 3 is a cross-sectional view showing an assembled state of the fan motor according to the preferred embodiment of the present invention; and

FIGS. 4 and 5 are cross-sectional views showing assembled states of a fan motor according to another preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

A fan motor according to a preferred embodiment of the present invention, which is an outer rotor type, includes a fan, a shaft rotating the fan, a bearing rotatably supporting the shaft, and a bracket mounting the above-mentioned components on a set. The set may be a structure provided in a refrigerator and having the fan motor mounted thereon, as an example.

Here, the bracket has a bearing holder formed integrally therewith, wherein the bearing holder has a receiving space receiving the bearing formed therein and a core provided to the outside thereof. In addition, a hub formed to be extended from the bearing holder to a perimeter and receiving a printed circuit board (PCB) and a base formed to be extended from the hub to the perimeter are integrally formed and provided.

That is, by improving the structure of the bracket only serving to mount the fan motor on the set according to the prior art, the above-mentioned printed circuit board (PCB), the core, the bearing, and optionally, a washer, a molding, and the like may be assembled and assembling positions thereof may be further determined.

Therefore, the above-mentioned bracket is provided, thereby making it possible to easily reduce the number of all the parts of the fan motor and to easily manage assembly tolerance.

Meanwhile, a fan motor according to another preferred embodiment of the present invention, which is an outer rotor type, includes a fan, a shaft to which the fan is fastened, a bearing rotatably supporting the shaft, and a bracket mounting the above-mentioned components on a set.

Here, the bracket has a bearing holder formed integrally therewith, wherein the bearing holder has a receiving space receiving the bearing and an installing space separated from the receiving space by a partition formed therein, and a core provided to the outside thereof. In addition, a hub formed to be extended from the bearing holder to a perimeter and receiving a printed circuit board (PCB) and a base formed to be extended from the hub to the perimeter are integrally formed and provided.

Further, the fan motor includes a stopper fastened to one end of the shaft penetrating through the receiving space to be exposed to the installing space. That is, the stopper is to prevent floating of the fan and improves the structure using a snap ring according to the prior art. Moreover, the fan motor may further include a case capable of preventing oil leakage and foreign material permeation by sealing the installing space, thereby making it possible to improve driving stability and reliability of the fan motor.

Hereinafter, preferred embodiments of the present invention are described hereafter in detail with reference to the accompanying drawings.

[Embodiment 1]

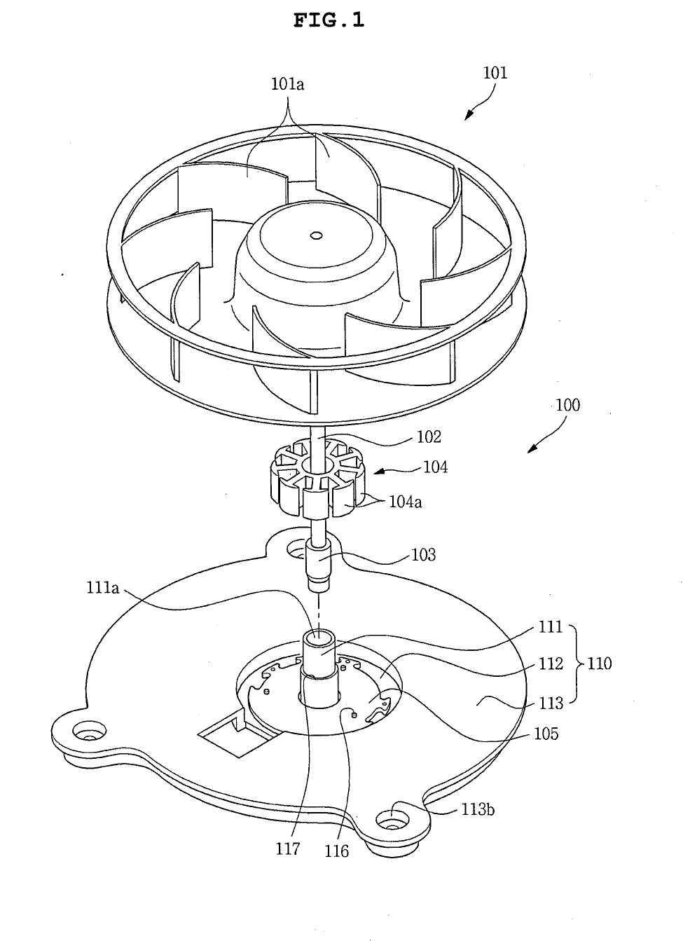

As shown in FIG. 1, the fan 101 configuring the fan motor 100 has a blade 101a provided so as to be formed in a propeller shape so that air may be ventilated in a shaft line direction. In addition, the shaft 102 and the bearing 103 are provided to be formed in circular column and cylindrical shapes so that the fan 101 provided over the shaft 102 and the bearing 103 may be rotatably supported. However, since the configurations of the fan 101, the shaft 102, and the bearing 103 are well known and may be easily implemented without a detailed description thereof, the detailed description thereof will be omitted.

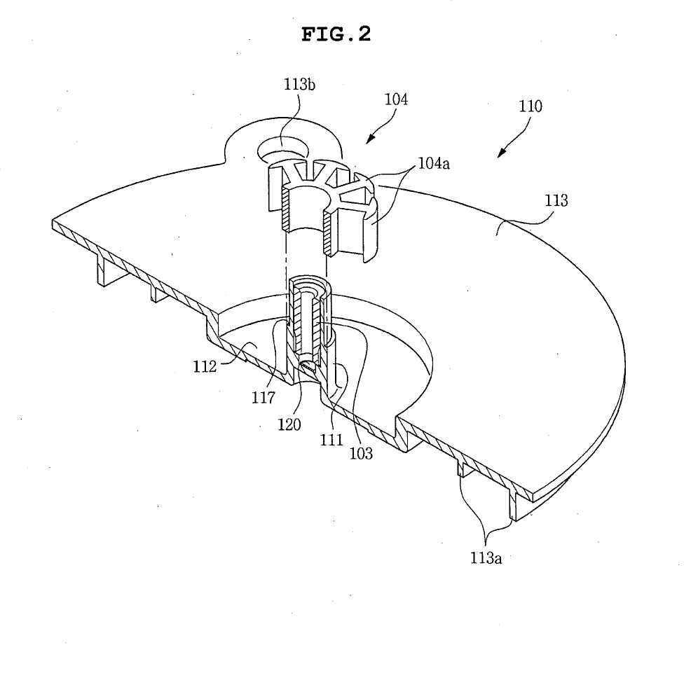

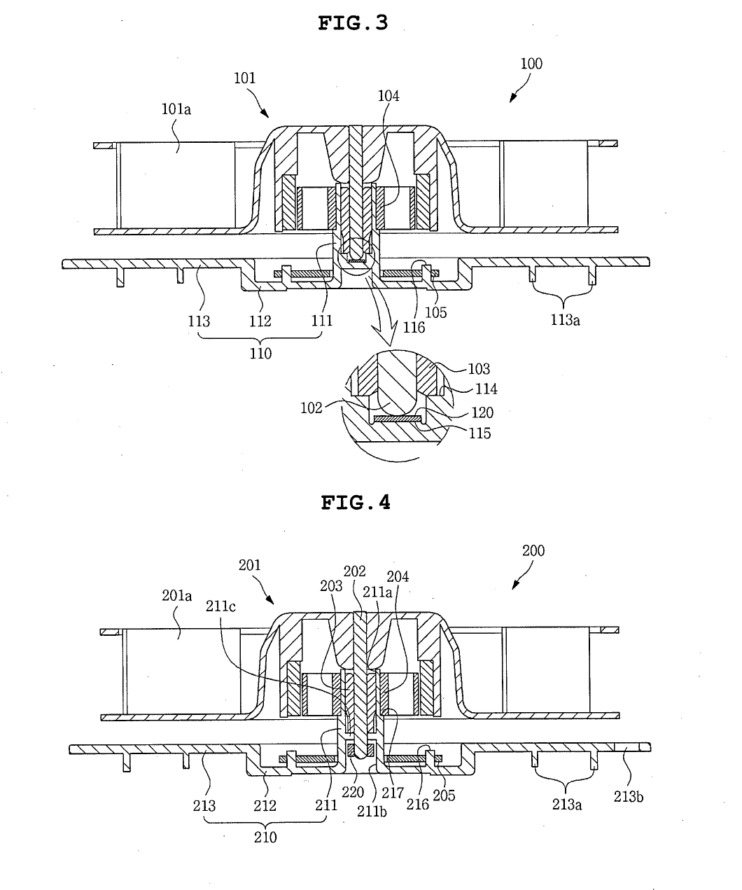

As shown in FIGS. 2 and 3, the bracket 110 configuring the fan motor 100 has the circular bearing holder 111 formed at the central portion thereof to be upwardly protruded, the circular hub 112 formed at a perimeter of a lower portion of the bearing holder 111 to be extended, and the base 113 formed at a perimeter of the hub 112 to be extended, such that they are entirely integrated.

The bearing holder 111 receives the bearing 103 rotatably supporting the shaft 102 by having a core 104 having a plurality of salient poles 104a provided to the outside and a receiving space 111a formed therein. A bottom of the receiving space 111a is installed with a washer 120 for supporting an end of the shaft 102.

Here, the receiving space 111a has an inner wall and the bottom formed in a step shape so that heights of the bearing 103 and the washer 120 may be easily adjusted and matched, thereby forming a step part 114 and a protrusion part 115. In addition, the bearing holder 111 has a step shape by forming an aperture of an upper portion to be smaller than that of a lower portion, thereby forming a catching part 117 capable of easily adjusting and matching a height of the core 104.

The hub 112 is formed by horizontally and vertically bending the lower portion of the bearing holder 111 to the perimeter thereof so as to have a concave depressed shape, when being entirely viewed, and has a printed circuit board 105 provided thereon. In this case, the hub 112 has a plurality of protrusions radially arranged and formed thereon around the bearing holder 111 as a fixing part 116, such that a motion of the printed circuit board 105 is fixed.

The base 113 is formed by horizontally bending the upper portion of the hub 112 to the perimeter thereof so as to have a disk shape, when being entirely viewed. In addition, a lower portion and a circumference of the base 113 are provided with a plurality of coupling protrusions 113a and holes 113b for coupling with the set, such that the fan motor 100 may be easily mounted on the set.

Therefore, the fan motor 100 according to the preferred embodiment of the present invention including the bracket 110 having the above-mentioned base 113, hub 112, and bearing holder 111 formed integrally with one another may minimize the process and tolerance for assembling each configuration and may easily determine a position between the respective configurations using the bracket 110, thereby making it possible to easily satisfy the requirements from a set manufacturer.

[Embodiment 2]

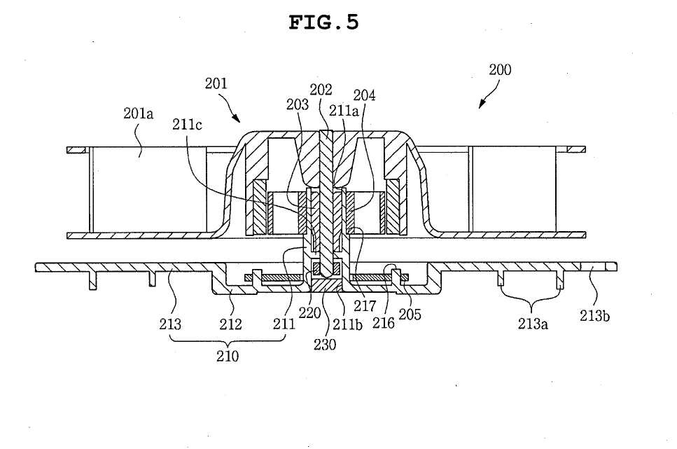

As shown in FIGS. 4 and 5, a fan 201 configuring a fan motor 200 has a blade 201a provided so as to be formed in a propeller shape so that air may be ventilated in a shaft line direction. In addition, a shaft 202 and a bearing 203 are provided to be formed in circular column and cylindrical shapes so that the fan 201 provided over the shaft 202 and the bearing 203 may be rotatably supported.

Meanwhile, a bracket 210 configuring the fan motor 200 has a circular bearing holder 211 formed at the central portion thereof to be upwardly protruded, a circular hub 212 formed at a perimeter of a lower portion of the bearing holder 211 to be extended, and a base 213 formed at a perimeter of the hub 212 to be extended, such that they are entirely integrated.

The bearing holder 211 receives the bearing 203 in the receiving space 211a, wherein the bearing 203 has a core 204 provided to the outside thereof and a receiving space 211a and an installing space 211b formed therein to be separated by a partition 211c, thereby rotatably supporting the shaft 202.

In this case, the bearing holder 211 has a step shape by forming an aperture of an upper portion to be smaller than that of a lower portion, thereby forming a catching part 217 capable of easily adjusting and matching a height of the core 204 provided to the outside thereof.

In addition, an end of the shaft 202 penetrating through the receiving space 221 a to be exposed to the installing space 211b is fastened with a stopper 220 and a lower portion of the stopper 220 is assembled with a case 230 for sealing the installing space 211b.

The stopper 220 has a donut shape, is formed by injecting plastic, and is fastened by press-fitting it to an end of the shaft 202. Therefore, in the case in which the shaft 202 floats along the fan 201, the stopper 220 is intermitted by the partition 211c, thereby preventing the floating. As a result, the protrusion of the fan 201 may be prevented.

The case 230 is formed in a circular shape, and is installed in the installing space 211b by a method such as press-fitting, or the like and is sealed, thereby preventing oil leakage dropping on the bearing 203 and permeation of a foreign material containing vapor into the bearing 203.

Meanwhile, the hub 212 is formed by horizontally and vertically bending the lower portion of the bearing holder 211 to the perimeter thereof so as to have a concave depressed shape, when being entirely viewed, and has a printed circuit board 205 provided thereon. In this case, the hub 212 has a plurality of protrusions radially arranged and formed thereon around the bearing holder 211 as a fixing part 216, such that the printed circuit board 205 is fixed.

The base 213 is formed by horizontally bending the upper portion of the hub 212 to the perimeter thereof so as to have a disk shape, when being entirely viewed. In addition, a lower portion and a circumference of the base 213 are provided with a plurality of coupling protrusions 213a and holes 213b for coupling with the set, such that the fan motor 200 may be easily mounted on the set.

Therefore, the fan motor 200 according to another preferred embodiment of the present invention including the bracket 210 having the above-mentioned base 213, hub 212, and bearing holder 211 formed integrally with one another may minimize the process and tolerance for assembling each configuration and may easily determine a position between the respective configurations using the bracket 210, thereby making it possible to easily satisfy the requirements from a set manufacturer and to easily prevent fan protrusion, oil leakage, and permeation of foreign material containing vapor existing in a refrigerator.

According to the preferred embodiment of the present invention, the bracket in which the bearing holder, the hub, and the base are integrally formed is provided, such that the parts and the assembly process are effectively reduced, thereby making it possible to maximize a design margin for the parts and the assembly tolerance. In addition, the number of management parts is reduced, thereby improving the management convenience.

Meanwhile, according to another preferred embodiment of the present invention, the stopper is provided instead of the snap ring according to the prior art and the case is provided so as to be provided in the bracket, thereby making it possible to improve convenience of the assembly process and driving stability due to the reduction of the shafting. In addition, the oil leakage and the foreign material permeation are prevented, thereby making it possible to improve reliability.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A fan motor, comprising:
a shaft having a fan fastened thereto;
a bearing rotatably supporting the shaft; and
a bracket having a bearing holder having a receiving space receiving the bearing formed therein and a core provided to the outside thereof, a hub formed to be extended from the bearing holder to a perimeter thereof and receiving a printed circuit board, and a base formed to be extended from the hub to a perimeter thereof formed integrally with one another.

2. The fan motor as set forth in claim 1, wherein the receiving space is provided with a step part for matching a height of the bearing.

3. The fan motor as set forth in claim 1, wherein the receiving space is provided with a washer.

4. The fan motor as set forth in claim 3, wherein the receiving space is provided with a protrusion part for matching a height of the washer.

5. The fan motor as set forth in claim 1, wherein the hub is provided with a fixing part fixing the printed circuit board (PCB).

6. The fan motor as set forth in claim 1, wherein the bearing holder has a catching part for matching a height of the core formed at the outside thereof.

7. A fan motor, comprising:
a shaft having a fan fastened thereto;
a bearing rotatably supporting the shaft;
a bracket having a bearing holder having a receiving space receiving the bearing and an installing space separated from the receiving space by a partition formed therein and a core provided to the outside thereof, a hub formed to be extended from the bearing holder to a perimeter thereof and receiving a printed circuit board, and a base formed to be extended from the hub to a perimeter thereof formed integrally with one another; and
a stopper penetrating through the receiving space so as to be fastened to one end of the shaft exposed to the installing space.

8. The fan motor as set forth in claim 7, wherein the stopper is formed by injecting plastic.

9. The fan motor as set forth in claim 7, further comprising a case sealing the installing space.

10. The fan motor as set forth in claim 7, wherein the base is provided with a fixing part fixing the printed circuit board (PCB).

11. The fan motor as set forth in claim 7, wherein the bearing holder has a catching part for matching a height of the core formed at the outside thereof.
